(19) United States
(12) Patent Application Publication
(10) Pub. No.: US 2015/0210470 A1
(43) Pub. Date: Jul. 30, 2015

(54) SEMI-UNDERGROUND WASTE SYSTEM USING A QUICK REPLACEMENT REINFORCED LINER

(71) Applicant: Deep Green USA, LLC, Greenville, SC (US)

(72) Inventors: Bernard Jean Jacques Melloul, Waterloo (CA); Brian D. Brandon, Greenville, SC (US)

(73) Assignee: Deep Green USA, LLC, Greenville, SC (US)

(21) Appl. No.: 14/165,689

(22) Filed: Jan. 28, 2014

(51) Int. Cl. B65F 1/14; B65F 1/06; B09B 1/00; B65D 90/10

(52) U.S. Cl. CPC B65F 1/1447; B65D 90/105; B65F 1/068; B65F 1/1623; B09B 1/006; B65F 2250/1143

(57) ABSTRACT

A system may include a utility chamber that is partially installed below a surface of ground; a lid, removably attached to the utility chamber, that covers an opening in a portion of the utility chamber that is above the surface of the ground; and a liner that stores waste and that includes one or more reinforcement components. The liner may be located inside the chamber and may be attached to the lid via the opening. The reinforcement components may be of sufficient strength to preclude the liner from expanding or becoming stuck in the utility chamber after the waste is inserted in the liner or when the lid is removed from the utility chamber to dispose of the waste.

### BACKGROUND

Commercial waste disposal systems usually include an industrial container (e.g., a dumpster) that rests on the ground and into which waste material is placed and temporarily stored until the container is emptied into a vehicle for disposal in a landfill (hereinafter, “above-ground waste disposal systems” or “above-ground systems”). The container is usually an unsightly, metal container that is located on or near the premises of a business that is authorized to use the container (e.g., in a parking lot, near an access door, etc.). The container and the waste material therein are often a haven for pests (e.g., rodents, insects, germs, etc.), harbor unpleasant odors due to decaying waste, and occupy precious real estate for the dumpster and access thereto that could be used for other purposes (e.g., parking, green space, etc.). The vehicle that is used to empty the container and dispose of the waste usually includes a forklift-like lifting mechanism to raise, tilt and evacuate the waste into the holding bin of the truck.

Other commercial waste disposal systems include a container that is entirely or partially installed within the ground and covered by an above-ground lid that can be opened to insert waste into a removable bin or liner within the container (hereinafter “conventional semi-underground waste disposal systems” or “conventional semi-underground systems”). A bin or liner can be raised by a hydraulic lifting arm attached to a vehicle to permit the waste to be evacuated from the bin or liner into the vehicle for disposal in a landfill. The subterranean nature of these conventional semi-underground systems have certain advantages over the above-ground system, such as enabling the waste to be stored in a cooler environment (e.g., thus slowing or reducing decay of the waste and reducing odors), being less unsightly, and being more space efficient.

Some such systems use a structurally rigid bin that can be raised by the vehicle to permit the waste to be evacuated into the vehicle by actuating one or more doors on the bottom or sides of the container (hereinafter, “rigid-bin semi-underground systems” or “rigid-bin systems”). The weight and complexity of these rigid-bin systems tend to make them more expensive to procure, install, operate and maintain than the above-identified above-ground systems.

Other conventional semi-underground systems use a lid to which a flexible liner is attached rather than a rigid bin. The flexible liner holds the waste within the container until the lid is raised, along with the liner, and is emptied into the vehicle for disposal in a landfill. The container used in the conventional semi-underground system remains in the ground and is usually associated with a tapered shape (e.g., such as that of an elliptic parabaloid, a conical frustum, a pyramid frustum, etc. in which the open end is facing upward) to enable the liner to be removed easily from the container when the liner expands and/or deforms due to the storage of waste and/or when capacity is reached. The tapered shape, however, has less capacity than a non-tapered cylindrical shape and may permit the container to come out of the ground over time, during a soaking rain, or due to a flood due to buoyant forces. Pre-cast concrete versions of these containers have been manufactured to create sufficient weight to remedy this problem, but the cost to transport these containers is high relative to containers made with lighter materials (plastic, metal, etc.) or above-ground containers. Additionally, the flexible liners are usually made of a durable woven and/or textile product for which replacement involves a scheduling and conducting a maintenance operation that can take many hours (e.g., 2 hours, 4 hours, six hours, etc.) outside of normal waste pick-up and disposal operations. Thus, the complexity of the conventional semi-underground systems cause such systems to be more expensive to procure, transport, install, operate and/or maintain than the above-identified dumpster-based systems.

### SUMMARY

According to one possible implementation, a semi-underground waste system may include a utility chamber that is partially installed below a surface of ground; and a lid, removably attached to the utility chamber, that covers an opening in a portion of the utility chamber that is above the surface of the ground. The system may also include a liner to that stores waste and that includes one or more reinforcement components. The liner may be located inside the utility chamber and attached to the lid via the opening. The one or more reinforcement components may be of sufficient strength to preclude the liner from expanding or becoming stuck in the utility chamber after the waste is inserted in the liner or when the lid is removed from the utility chamber to dispose of the waste.

According to another possible implementation, a semi-underground waste system may include a utility chamber that includes a first portion and a second portion. The first portion may be installed at or below a surface of ground, and the second portion may be installed above the surface of the ground and may include an opening that permits access to the first portion and the second portion. The system may also include a lid that covers the opening when the lid is removably attached to the second portion, a liner to store waste. The liner may be located inside of the utility chamber and may be attached to the lid to permit the liner and the stored waste to be removed from the utility chamber when the lid is removed from the second portion. The liner may include at least one of: one or more reinforcements of sufficient strength to preclude the liner from becoming stuck in the utility chamber when the liner is at or near capacity to store the waste, or one or more fasteners that enable the liner to be removed and replaced within a first time period that is less than a second time period to remove and replace a particular liner associated with a conventional semi-underground waste system.

According to a further possible implementation, a semi-underground waste device may include a liner that is made of a flexible material to store waste. The liner may include a group of fasteners that are attached to an open end of the liner. The device may also include a lid to which the liner is attached by the group of fasters and that covers the open end of the liner. The group of fasteners may enable the liner to be detached from the lid and replaced within a first time period that is less than a second time period during which a conventional liner is removed and replaced from a conventional semi-underground waste system. The device may further include a utility chamber, partially installed below ground, that includes an opening above the ground through which the liner can be inserted into the utility chamber when the lid is placed over the opening, or the liner and the stored waste can be removed from the utility chamber when the lid is removed from the opening.

### DESCRIPTION OF THE DRAWINGS

FIG. 1A is a diagram of an example environment in which the systems, methods, technologies, and/or techniques described herein are implemented;

FIG. 1B is a diagram of an example flexible liner semi-underground waste disposal system of FIG. 1A;

FIGS. 2A and 2B are diagrams of an example utility chamber of FIGS. 1A and 1B;

FIGS. 3A-3D are diagrams of example components of a lid of FIGS. 1A & 1B;

FIGS. 4A and 4B are diagrams of example portions of semi-underground waste disposal system of FIGS. 1A and 1B that may identify components of a different types of fasteners associated with a flexible liner;

FIGS. 5A-5F are diagrams of example flexible liners that may be associated with a flexible liner semi-underground waste disposal system; and

FIGS. 6A and 6B are diagrams of example flexible liners and a bundle of flexible liners that may be associated with a flexible liner semi-underground waste disposal system.

### DETAILED DESCRIPTION

The systems, methods, technologies, and/or techniques (hereinafter referred to as the “technologies and/or techniques”), described herein, may include a flexible liner semi-underground waste disposal system (hereinafter, a “semi-underground waste system”) that uses a semi-underground container that is based on a modified conventional utility chamber commonly used in public and/or industrial utility systems associated with sewage, water, telecommunications, electricity, storm drains, gas, etc. The utility chamber, to be described in greater detail below, may be made of pre-cast concrete and/or may correspond to a modified conventional manhole (e.g., a manhole that does not include an access ladder, any opening for pipe connections, etc.), a modified sewage pipe assembly (e.g., a pipe with one end closed, that does not include any opening for pipe connections, etc.), etc. A portion of the utility chamber may be installed in the ground and may resist buoyant forces due to the weight and non-tapered shape (e.g., cylindrical, cubical, etc.) of the utility chamber. Additionally, or alternatively, the utility chamber may have a greater capacity than the tapered shape associated with containers used in conventional semi-underground systems. The utility chamber may be manufactured at numerous sites and manufacturers throughout North America, Europe, Asia, etc. These manufacturers are usually located within short distances from each other (e.g., 50, 100, 150, etc. miles), which may render transportation costs for such utility chambers less than that associated with custom, pre-cast concrete containers used in conventional semi-underground systems. Additionally, or alternatively, the costs of the utility chamber may be less than that associated with custom pre-cast concrete containers or non-concrete containers used in conventional semi-underground systems.

The technologies and/or techniques may also, or alternatively, include a flexible liner that is attached to a substructure of a lid that fits over an above-ground opening of the utility chamber. The liner may be made of a single or multi-ply, environmentally compatible, and/or non-woven material that is breathable and resistant to water penetration. The cost of the liner material may be lower than that of woven textile liners of conventional semi-underground systems. The technologies and/or techniques my also, or alternatively, include an attachment and quick release mechanism that enables the liner to be easily and quickly removed and/or replaced from the lid without arranging a separate maintenance operation as is required for conventional semi-underground systems. The quick remove and replacement operation may be performed during normal waste pickup and disposal operations which may reduce operational costs of the semi-underground waste system relative to those of the conventional semi-underground system.

The technologies and/or techniques may include liner reinforcement components associated with the liner of the semi-underground waste system. The liner reinforcement components may include components, such one or more extruded metal components, wires, cables, cords, straps, strings, ropes, etc. that are integrated or attached to the exterior, interior or between one or more plies of the liner to maintain approximately the original shape of the liner when waste is deposited within the liner and/or when the liner has reached capacity. Maintaining the approximate original shape of the liner may preclude the liner from expanding and/or deforming, and/or becoming immovably jammed, lodged, or stuck within the utility chamber; thus, making the waste pickup and disposal operation difficult, more expensive, and more time consuming. Additionally, or alternatively, the liner reinforcement components may be integrated with the liner during manufacture, prior to shipping, or in the field during a removal or replacement operation of the liner. The liner reinforcement mechanism may be flexible so as to permit the flexible liner to be collapsed, folded, stacked, and/or bundled with other liners for efficient storage, shipping, and/or portability during field operations.

The description below describes the semi-underground waste system as being generally of a cylindrical in shape for explanatory purposes. In other implementations, the shape need not be so limited. Additionally, or alternatively, the semi-underground waste system may correspond to a cuboid, frustum, spheroid, etc. shape in other implementations.

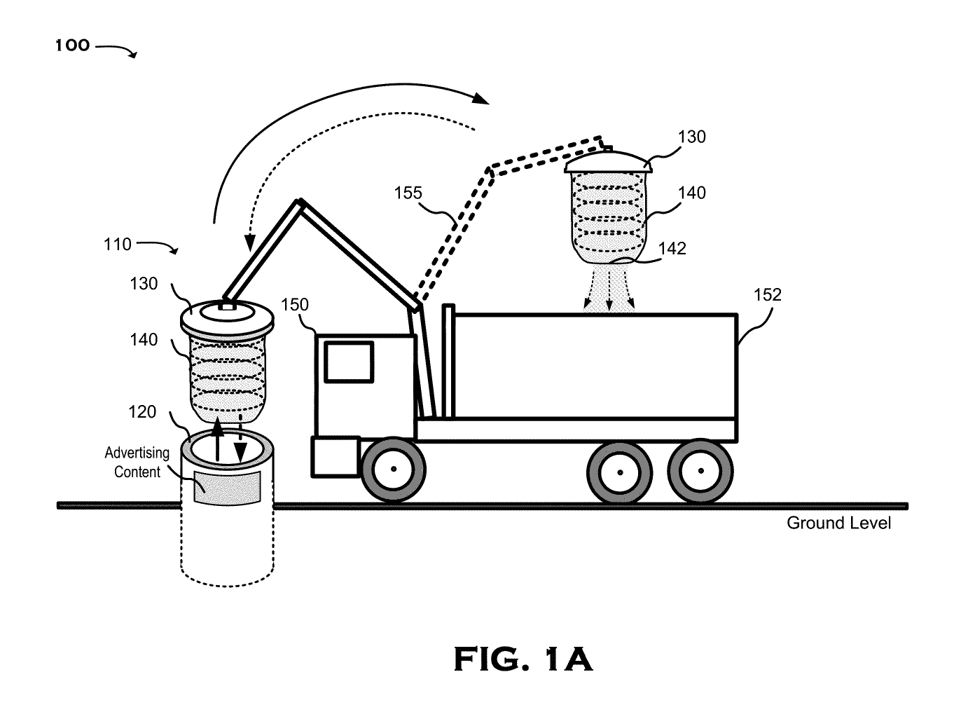

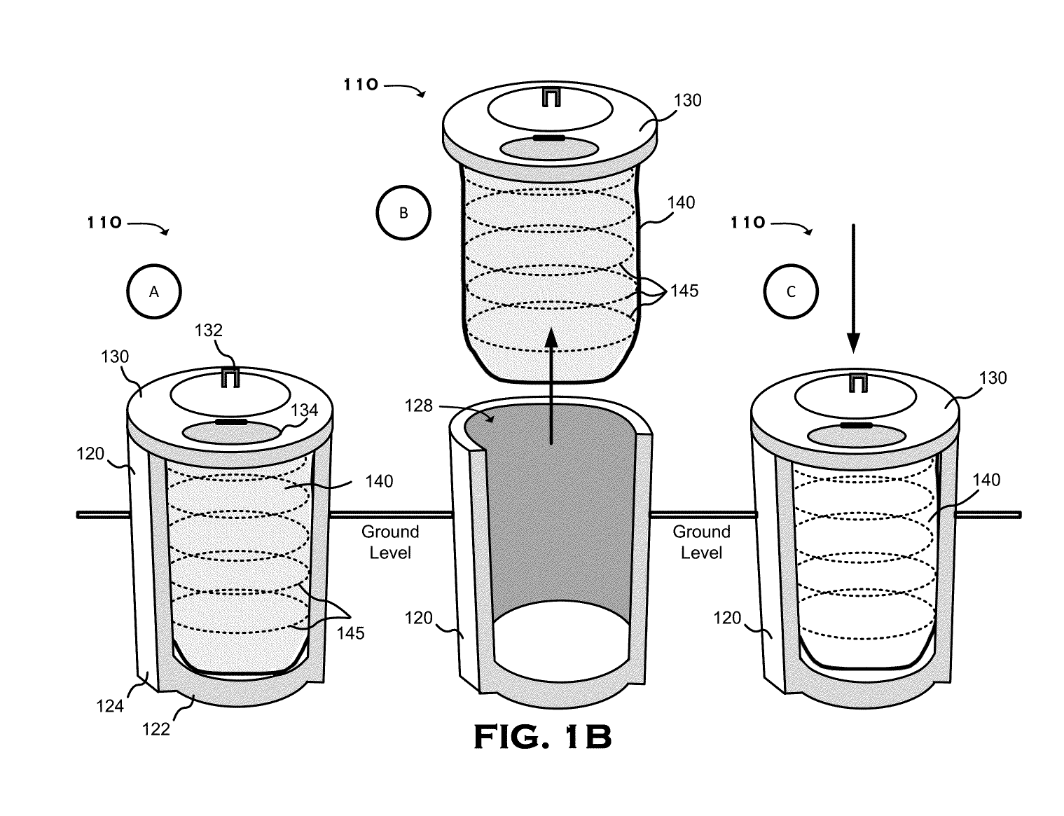

FIG. 1A is a diagram of an example environment 100 in which the systems, methods, technologies, and/or techniques described herein are implemented. As shown in FIG. 1A, environment 100 may include a semi-underground waste disposal system 110 (hereinafter “semi-underground waste system 110”) and a waste disposal truck 150 (hereinafter, “truck 150”). Semi-underground waste system 110 may include a utility chamber 120, a lid 130, and a flexible liner 140 (hereinafter, “liner 140”).

Utility chamber 120, to be described in greater detail below, may include a pre-cast assembly that includes one or more walls (e.g., in the shape of a cylinder, cube, etc.) that are enclosed at one end (e.g., the bottom end) that is installed below ground level and/or open at the other end that is above ground level. Utility chamber 120 may, for example, be based on a modified conventional pre-cast concrete manhole or sewage pipe assembly without any rungs of a ladder that would normally be used to permit a person to enter and exit utility chamber 120 when used for normal sewer or water system applications. The portion of the utility chamber that is above ground level may include information, shapes, colors, alphanumeric characters and/or symbols, etc. such as, for example, advertising, instructions, warnings pertaining to waste stored therein, a camouflage pattern, etc. (hereinafter “Advertising Content” as shown in FIG. 1A).

Lid 130, to be described in greater detail below, may be made of a material and/or include a substructure of sufficient strength rigidity to enable liner 140 to be attached and hoisted (by truck 150) when liner 140 has reached capacity. Lid 130 may correspond to a shape that enhances the strength and/or or rigidity of lid 130, and/or that enables lid 130 to cover and maintain a snug fit over the open end of utility chamber 120 when lid 130 is placed on utility chamber 120 over the open end of utility chamber 120. Lid 130 may be easily removed from utility chamber 120 by a user of semi-underground waste system 110 or by hoisting arm 155 (described below). Lid 130 may include Advertising Content. (not shown in FIG. 1A).

Liner 140, to be described in greater detail below, may include a flexible material of sufficient strength to store and/or hoist waste. For example, liner 140 may be made of a single or multi-ply, environmentally compatible, and/or non-woven material that is flexible, breathable, and/or resistant to water penetration, such as a flash spun, high-density polyethylene fiber material (e.g., the Tyvek® brand and/or other brand names), a polyvinyl chloride/ethylene vinyl acetate (PVC/EVA) coated fabric material, polyethylene vinyl acetate (PEVA) coated fabric material, a urethane coated fabric material, a polyurethane coated fabric material, and/or some other material. Liner 140 may also, or alternatively, include one or more heat welded seams that may enable liner 140 to be less cost than a conventional stitched seam liner. Liner 140 may include Advertising Content (not shown in FIG. 1A), Liner 140 may be attached to lid 130. Liner 140 may also, or alternatively, include an emptying component 142 at or near the bottom end of liner 140 that enables waste to be evacuated from liner 140 due to the force of gravity. Emptying component 142 may, for example, include a draw string that can be released to cause the bottom of liner 140 to open and the waste to be evacuated, from liner 140. The draw string may be pulled to cause liner 140 to close for reinsertion into utility chamber 120.

Truck 150 may include a conventional waste disposal truck that includes a holding bin 152 and a hoisting arm 155. Holding bin 152 may be a temporary storage bin that receives the waste that is evacuated from liner 140 via emptying mechanism 142. Holding bin 152 may include a compactor mechanism that compresses the waste and/or may include a mechanism to tilt holding bin 152 and/or evacuate waste from holding bin 152 for dumping in a landfill, Hoisting arm 155 may include one or more components such as joints, levers, hydraulics, etc. For example, hoisting arm 155 may include one or more components that can be attached to lid 130 and hoist and/or pivot lid 130, liner 140 (e.g., as shown by the curved solid arrow in FIG. 1A), and the waste held within liner 140 for disposal within holding bin 152, Hoisting arm 155 may also, or alternatively, hoist and/or pivot lid 130 and emptied liner 140 for replacement over and within utility chamber 120, respectively.

FIG. 1B is a diagram of a cut away view of an example semi-underground waste system 110. As shown in indication A of FIG. 1B, semi-underground waste system 110 includes a collection of components described above with respect to FIG. 1A, such as utility chamber 120, lid 130 and liner 140. Utility chamber 120 may be a monolithic body in the shape of a hollow cylinder, cube, etc. with an opening 128 at one end. As shown with respect to indication B of FIG. 1B, opening 128 and a portion utility chamber 120 may be installed above ground level and the remaining portion utility chamber 120 may be installed below ground level. Additionally, or alternatively, utility chamber 120 may not be constructed of a monolithic body and may, for example, include one or more components, such as a base 122, and/or a body 124. In this example, base 122 may include a precast concrete material that caps the bottom end of utility chamber 120. Base 122 may, for example, be attached and/or sealed to a bottom end of body 124 to prevent waste from seeping into the ground adjacent to utility chamber 120 and/or water or debris from entering utility chamber 120 from the adjacent ground. Body 124 may include a pre-cast hollow concrete cylinder, cuboid, or other shape with a bottom end that is beneath the surface of the ground and to which base 122 is attached, and a top end that includes opening 128 that is open above ground level to permit liner 140 to be inserted and/or lid 130 to be removably attached or placed over opening 128.

Lid 130 may include a lift ring 132 that acts as a handle that permits a user, associated with semi-underground waste system 110, to grasp, open and/or remove lid 130 from utility chamber 120 and/or opening 128, and/or to place lid 130 on or over utility chamber 120 and/or opening 128. Lift ring 132 may also, or alternatively, be of sufficient strength and rigidity to permit hoisting arm 155 of truck 150 to attached and hoist lid 130, liner 140 and any waste stored therein to be lifted out of utility chamber 120 in a generally vertical direction as shown by indication B of FIG. 1B. Additionally, or alternatively, lift ring 132 may enable hoisting arm 155 to position lid 130 and/or liner 140 over holding bin 152 of truck 150 into which the waste is evacuated and to replace lid 130 on and empty liner 140 (e.g., shown as unshaded liner 140 with respect to indication C of FIG. 1B) in utility chamber 120. Hatch 134 may include a door, associated with lid 130, that enables a user to deposit waste in liner 140. Hatch 134 may include a hinge that enables the door to be opened and closed without becoming detached from lid 130.

Liner 140 may include one or more liner reinforcements 145 (hereinafter, each a “reinforcement 145” and collectively “reinforcements 145”). Reinforcements 145 may, for example, correspond to rings, cables, cord, etc. (e.g., extruded metal, wire, plastic, synthetic string or rope, etc.) associated with a diameter, shape, or circumference that is similar to the diameter, shape, or perimeter, respectively, of a cross section of liner 140. One or more reinforcements 145 may be attached to the liner 140 (e.g., by adhesive, heat welding, stitching, etc.) during manufacture, or in the field by a user of semi-underground waste system 110. Reinforcements 145 may enable the original shape of liner 140 to be maintained when liner 140 is partially or completely full of waste (e.g., shown as the shaded liner 140 of indications A and B of FIG. 1B). Maintaining the original shape of liner 140 may preclude liner 140 from expanding or deforming within utility chamber 120 thereby causing liner 140 to conform to the inside dimensions of utility chamber 120 and/or make contact therewith. Precluding such expansion or deformation may reduce friction forces between liner 140 and utility chamber 120 that may prevent liner 140 and the waste stored therein from become immovably lodged, jammed, or stuck in utility chamber 120. Additionally, or alternatively, the flexible material and/or reinforcement mechanism may enable liner 140 to be folded into a volume that is significantly less than an unfolded volume of liner 140, which may enable multiple folded liners 140 to be stacked, packaged, transported, etc. at less cost and volume than unfolded liners 140.

The number of systems, trucks and/or components shown with respect to environment 100 of FIG. 1A and/or semi-underground waste system 110 of FIG. 1B, is provided for explanatory purposes only. In practice, there may be additional systems, trucks and/or components; fewer systems, trucks and/or components; different systems, trucks and/or components; or differently arranged systems, trucks and/or components than illustrated with respect to environment 100 of FIG. 1A or semi-underground waste system 110 of FIG. 1B. Also, in some implementations, one or more of the components of semi-underground waste system 110 may perform one or more functions described as being performed by another one or more of the components of semi-underground waste system 110.

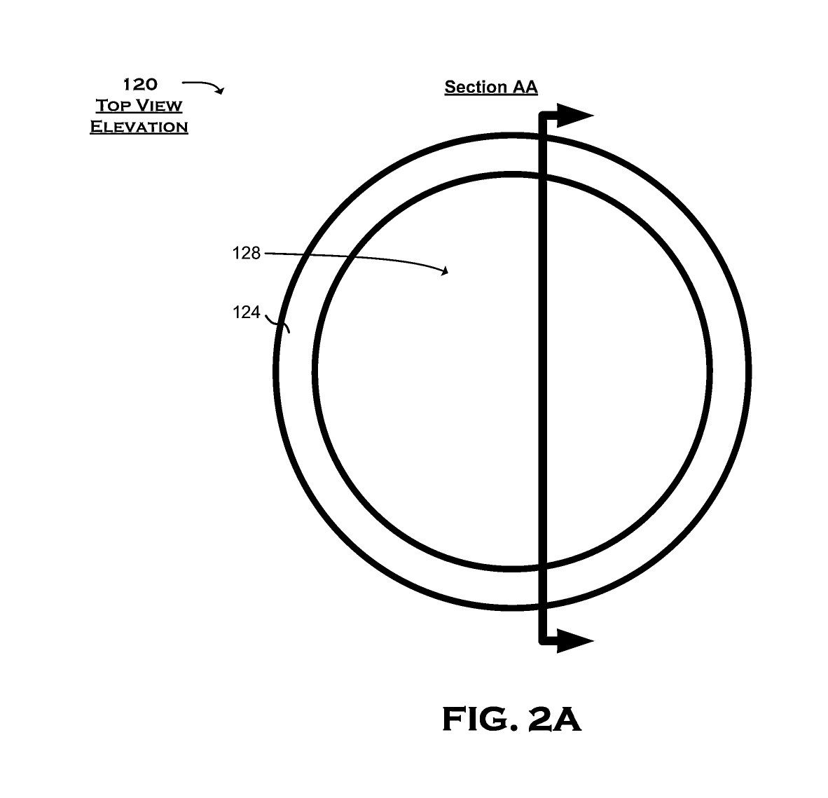

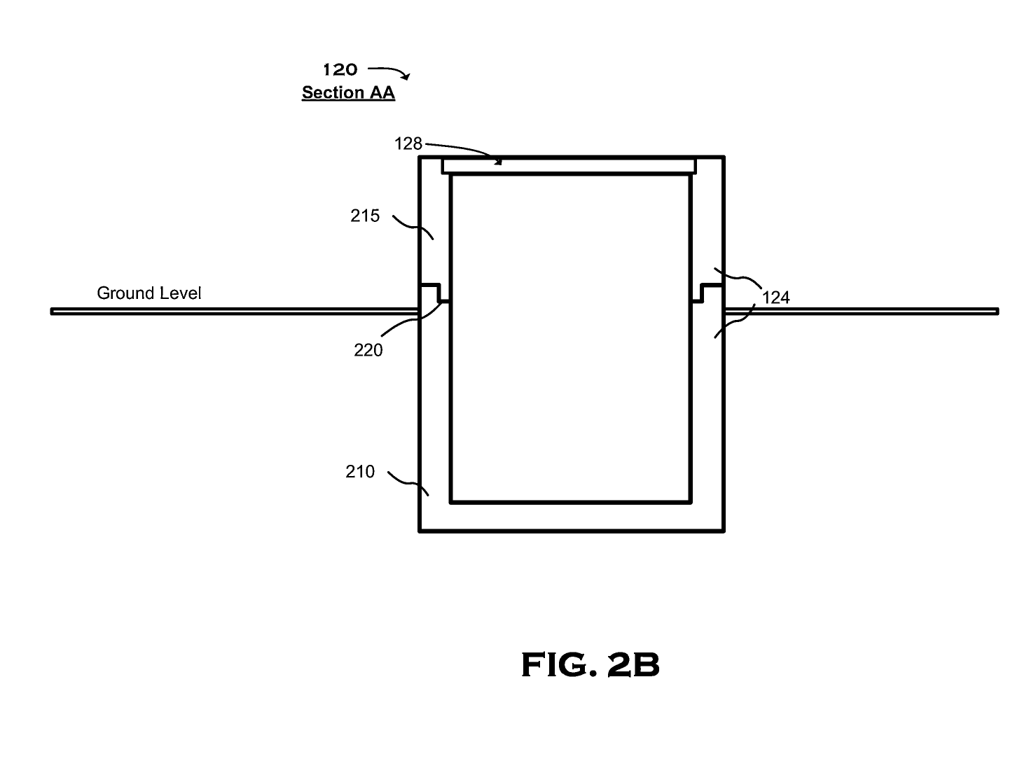

FIGS. 2A and 2B are diagrams of an example utility chamber 120. FIG. 2A includes a top view elevation of utility chamber 120 through opening 128, which identifies the circumference and thickness of wall 124, base 122 at the bottom, subterranean end of utility chamber 120. Section AA represents a cross section of utility chamber 120 as described in FIG. 2B.

As illustrated in FIG. 2B, section AA of utility chamber 120, may identify body 124 and opening 128 at the top, above-ground end of utility chamber 120. Body 124 may include a lower section 210, one or more upper sections 215 and one or more seals 220, Lower section 210 may be a one-piece monolithic body that acts as a base of utility chamber 120 and/or on which one or more upper section 215 are attached by stacking. The depth or capacity of utility chamber 120 may be increased by stacking one or more upper sections 215 on lower section 210 and/or a different upper section 215 that is stacked on lower section 210. The interface between each stacked upper section 215 and/or between lower section 210 and upper section 215 may include a seal 220 that is made of a flexible gasket material, such as rubber, epoxy, plastic, caulk, etc. that prevents waste, discharged from liner 140, from seeping into the ground adjacent to utility chamber 120 and/or may prevent water and/or debris from the ground from entering utility chamber 120. Additionally, or alternatively, seal 220 may be installed above the ground level or below the ground level.

The number of components shown with respect to utility chamber 120 of FIGS. 2A and/or 2B is provided for explanatory purposes only. In practice, there may be additional components, fewer components, different components, or differently arranged components than illustrated in FIGS. 2A and/or 2B. Also, in some implementations, one or more of the components of utility chamber 120 of FIGS. 2A and/or 2B may perform one or more functions described as being performed by another one or more of the components of utility chamber 120.

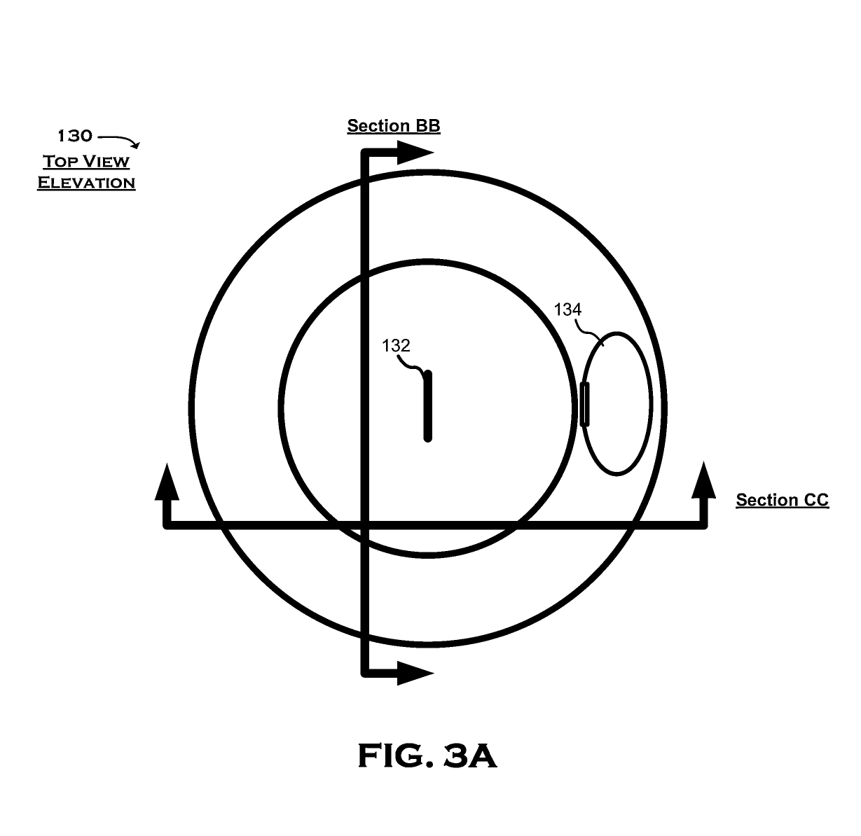

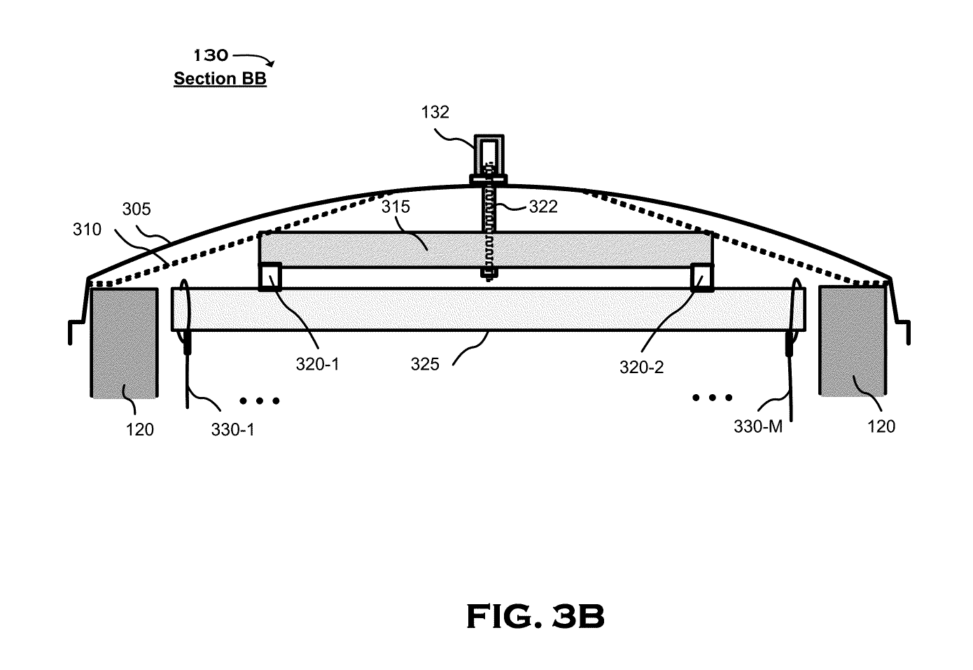

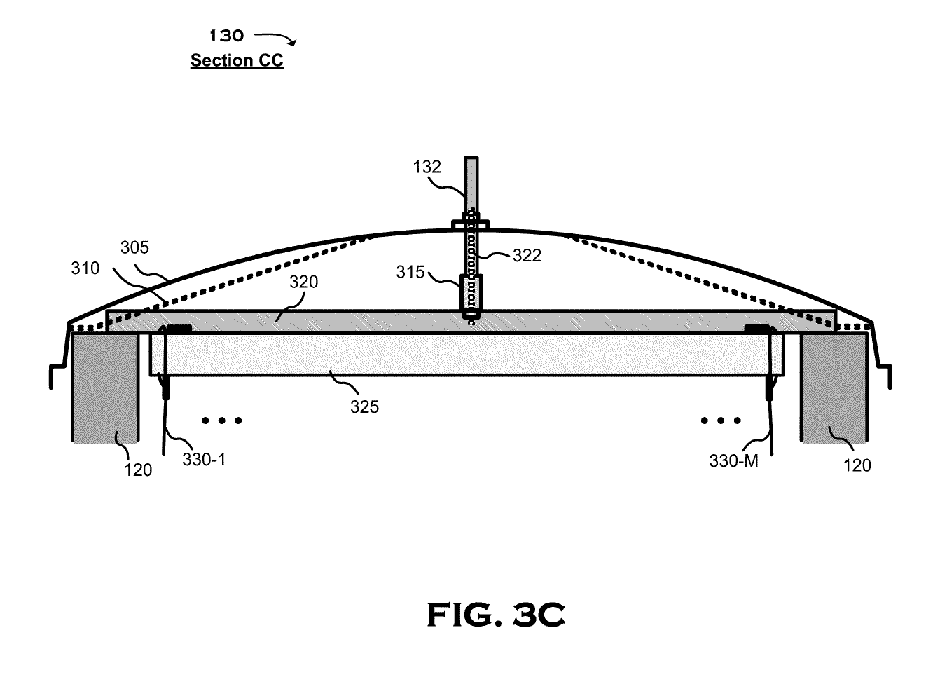

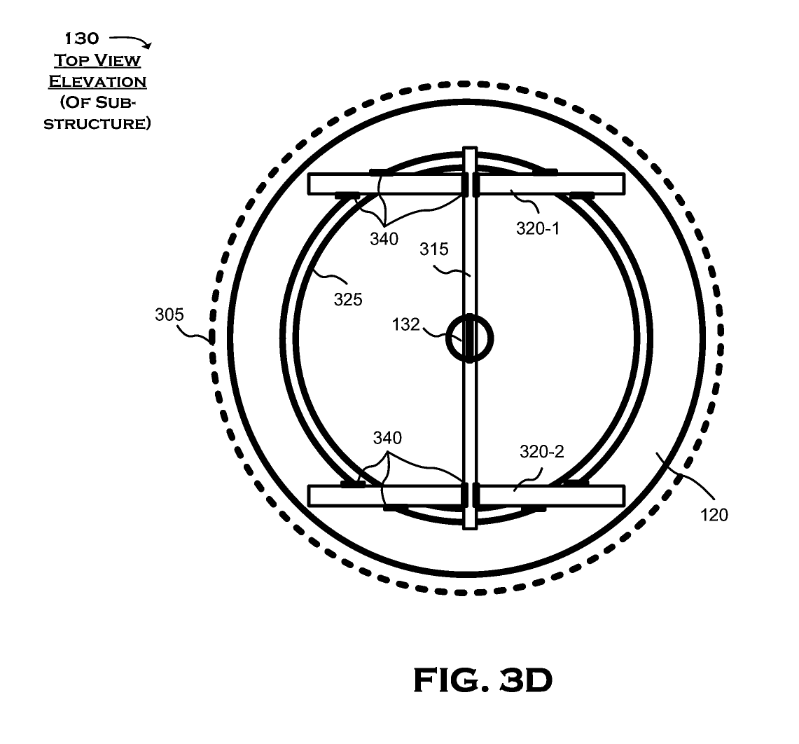

FIGS. 3A-3D are diagrams of example components of a lid 130. As shown in FIG. 3A, top view elevation of lid 130 may identify the shape and perimeter of lid 130, lift ring 132 and hatch 134. Section BB represents a cross section of lid 130 as described in FIG. 3B and Section CC represents a cross section of lid 130 as described in FIG. 3C.

As illustrated in FIG. 3B, Section BB of lid 130, may include utility chamber 120 and lift ring 132, and a collection of components associated with a substructure of lid 130, such as an outer cover 305, a lid depression 310, a main brace 315, a pair of cross members 320-1 and 320-2 (hereinafter, together “cross members 320” and individually, a “cross member 320”), attachment hardware 322, and a fastening plate 325. Section BB may also include a group of liner fasteners/quick release mechanisms 330-1, . . . , 330-M (where M≧1) (hereinafter, collectively “fasteners 330” and individually, a “fastener 330”) associated with liner 140.

Outer cover 305 may include a material (e.g., a metal, plastic, ceramic, composite, etc.) that is of sufficient rigidity to cover utility chamber 120 and to enable substructure components 310-325 to be attached to or supported by outer cover 305. Outer cover 305 may include a shape and dimensions that enable lid 130 to completely cover and/or overlap the maximum diameter of opening 128 and/or utility chamber 120. Lid depression 310 may correspond to one or more concave depressions and/or convex bulges that are integrated into the shape of outer cover 305 to reinforce outer cover 305 to prevent distortion when lid 130 is supporting liner 140 (e.g., with our without waste) and/or being lifted from utility chamber 120 by hoisting arm 155 of truck 150.

Main brace 315 may include a material (e.g., metal, ceramic, composite, plastic, etc.) that is of sufficient dimensions (e.g., thickness, length, width, etc.), rigidity and/or strength (e.g., tensile strength, compressive strength, shear, etc.) to carry any static and dynamic loads and forces imparted to main brace 315 by lift ring 132 and/or one or more cross members 320, particularly when lid 130 and liner 140 (e.g., in which waste is being held) are being hoisted from utility chamber 120 for disposal in truck 150 and/or when liner 140 is at or near capacity. Attachment hardware 322 may include one or more components (e.g., bolts, nuts, rivets, welds, washers, spacers, pins, etc.) that enable main brace 315 to be attached to external cover 305 and/or lift ring 132. Cross member 320 may include a material (e.g., metal, ceramic, composite, plastic, etc.) that is of sufficient dimensions (e.g., thickness, length, width, etc.), rigidity and strength (e.g., tensile strength, compressive strength, shear, etc.) to carry any static and dynamic loads and/or forces imparted to cross member 320 by main brace 315 and/or fastening plate 325, particularly when lid 130 and liner 140 (e.g., in which waste is being held) are being hoisted from utility chamber 120 for disposal in truck 150 and/or when liner 140 is at or near capacity. Cross member 320 may be attached (e.g., by welding, bolting, riveting, etc.) to main brace 315 and/or fastening plate 325.

Fastening plate 325, may include a material (e.g., metal, ceramic, composite, plastic, etc.) that is of sufficient dimensions (e.g., thickness, length, width, etc.), rigidity and strength (e.g., tensile strength, compressive strength, shear, etc.) to carry any static and dynamic loads and forces imparted to fastening plate 320 by one or more cross members 320 and/or one or more fasteners 330, associated with liner 140, particularly when lid 130 and/or liner 140 (e.g., in which waste is being held) are being hoisted from utility chamber 120 for disposal in truck 150 and/or when liner 140 is at or near capacity. Fastening plate 320 may include a shape and/or dimensions that correspond to the inside circumference or perimeter of opening 128 and/or that enable liner 140 to be kept open to permit waste to be discarded into liner 140 via hatch 134 (not shown in FIG. 3B). Such shape and/or dimensions may enable fastening plate 325 to fit within opening 128 of utility chamber 120 when lid 130 is placed over utility chamber 120.

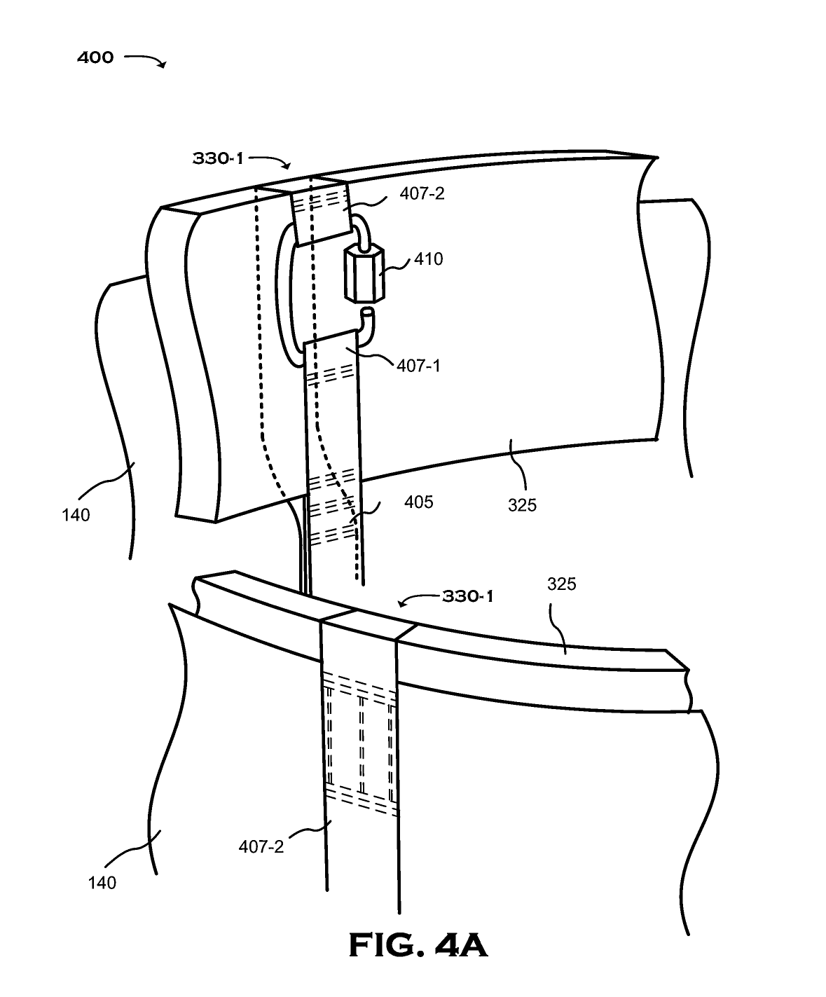

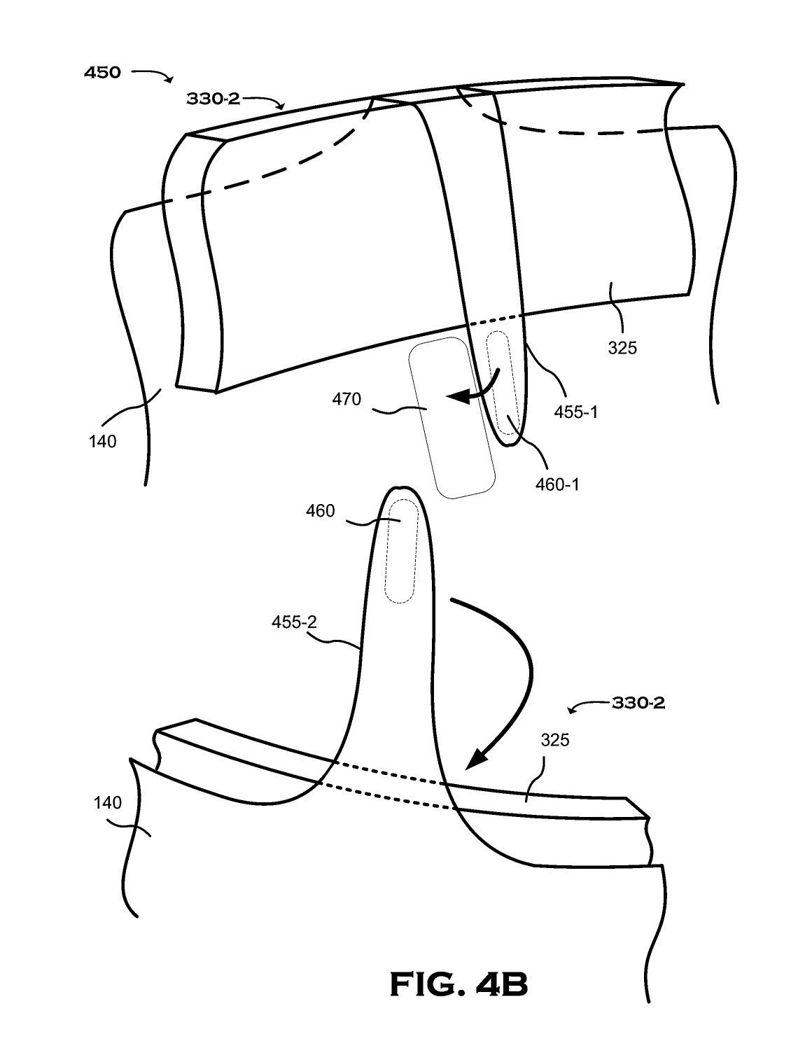

Fastener 330, to be described in greater detail below with respect to FIGS. 4A and 4B, may be made of a material of sufficient strength (e.g., tensile strength) to carry loads and forces between liner 140 and fastening plate 325, particularly when lid 130 and liner 140 (e.g., in which waste is being held) are being hoisted from utility chamber 120 for disposal in truck 150 and/or when liner 140 is at or near capacity. Fastener 330 may, for example, include a loop, strap, belt, and/or or some other material or component that can be attached, looped, or hung on fastening plate 325 to enable liner 140 to be fastened and/or suspended from fastening plate 325.

As illustrated in FIG. 3C, Section CC of lid 130, may include utility chamber 120 and lift ring 132, and a collection of components, associated with a substructure of lid 130, as described in FIG. 3B, such as outer cover 305, lid depressions 310, main brace 315, cross member 320, attachment hardware 322, and fastening plate 325. Section CC may also include fasteners 330 associated with liner 140. Section CC may be approximately orthogonal to Section BB of FIG. 3B. As shown in Section CC of FIG. 3B, cross member 320 may be of sufficient length to span the opening 128, such that cross member 320 makes contact with the top end of utility chamber 120 (e.g., the top end of body 124), Thus, cross member 320 may structurally support lid 130 when lid 130 is placed over opening 128 of utility chamber 120.

FIG. 3D is an example top view elevation of the substructure of lid 130. As illustrated in FIG. 3D, top elevation of the substructure of lid 130 may include utility chamber 120 and lift ring 132, and the collection of one or more of the components associated with a substructure of lid 130 as described in FIGS. 3B and 3C. For example, outer cover 305 (e.g., shown as the dashed circle of FIG. 3D) may represent the outer diameter of lid 130, Additionally, or alternatively, fastening plate 325 may include a diameter and/or other dimension that enables fastening plate 325 to fit inside opening 128 of utility chamber 120, Main brace 315, cross member 320-1 and 320-2, and fastening plate 325 may be attached to each other via bonds 340. Bonds 340 may correspond to welds, rivets, nuts, bolts, and/or some other bonding agent or mechanism by which main brace 315, cross members 320, and fastening plate 325 are joined and/or attached.

The number of components shown with respect to lid 130 of FIGS. 3A-3D is provided for explanatory purposes only. In practice, there may be additional components, fewer components, different components, or differently arranged components than illustrated in FIGS. 3A-3D. Also, in some implementations, one or more of the components of lid 130 of FIGS. 3A-3D may perform one or more functions described as being performed by another one or more of the components of lid 130.

FIGS. 4A and 4B are diagrams of example portions 400 and 450, respectively, of semi-underground waste system 110 (hereinafter “waste system portion 400” and “waste system portion 450”) that may identify components of different types of fasteners 330. As illustrated in FIG. 4A, waste system portion 400 may include fasteners 330-1, and a portion of fastening plate 325 and liner 140. Fastener 330-1 may enable liner 140 to be quickly and easily replaced by enabling liner 140 to be detached from lid 130 and a replacement liner 140 to be attached to lid 130 without scheduling a separate maintenance operation.

Each fastener 330-1 may be attached to an open end of liner 140 and include a collection of components such as a strap 405 and quick attached and release hardware 410 (hereinafter, “hardware 410”). Strap 405 may include a strap, band, ribbon, belt or the like that is made of a material (e.g., steel, polypropylene, polyester, nylon, paper, composite and/or other material) of sufficient flexibility and/or tensile strength to wrap around or attached to fastening plate 325 and/or to attach liner 140 to fastening plate 325 without failure or breaking particularly when liner 140 is at or near capacity and/or when lid 130 and/or liner 140 is being hoisted form utility chamber 120.

Strap 405 may include a first end that is attached to liner 140 through adhesive bonding, stitching, stapling, heat welding, riveting, snapping, tying, etc. Strap 405 may also, or alternatively, include a second end that is separated into a first strap end 407-1 and a second strap end 407-2. First strap end 407-1 and second strap end 407-2 may each include a respective loop through which hardware 410 can be fitted to connect hardware 410 to first and/or second strap end 407. Hardware 410 may include hardware that allows the second end of strap 405 to be easily connected to and/or around fastening plate 325 within a first time period that is less than a first threshold. Hardware 410 may also, or alternatively, include hardware that allows the second end of strap 405 to be easily disconnected from fastening plate 325 within a second time period that is less than a second threshold. Thus, detaching and reattaching liner 140 to lid 130 in the manner described above may be performed within a time period, which is based on a combination of the first time period and the second time period, that is less than a third threshold; the third threshold being based on a combination of the first threshold and second threshold. Hardware 410 may, for example, correspond to any fastening hardware that allows for quick connection and/or disconnection of first strap end 407-1 and second strap end 407-2. Hardware 410 may, for example, attach be attached to first strap end 407-1 and second strap end 407-2 to permit the second end of strap 405 to form a continuous closed loop that can be used to fasten strap 405 and/or liner 140 to fastening plate 325 (Hardware 410 is described and shown in FIG. 4A as being a quick link for explanatory purposes. Additionally, or alternatively, hardware 410 may include other types of such as, for example, any type of quick connect buckle, shackle, snap hook, bolt snap, quick link, strap buckle, etc.

By way of example, liner 140 may be connected to fastening plate 325 by attaching first strap end 407-1 to hardware 410 on a first side of fastening plate 325 (e.g., associated with an inside diameter of fastening plate 325). Additionally or alternatively, second strap end 407-2 may be looped around a second side (e.g., opposite the first side) and over a top edge of fastening plate 325, and may be attached to an upper portion of hardware 410. The connection may be secured when hardware 410 is engaged by turning the nut in a first direction (e.g., a clockwise direction) until hardware 410 is closed has no opening for strap 405 to become disconnected. To disconnect strap 405 from fastening plate 325, hardware 410 is disengaged by reversing the procedure described above: by turning the nut in a second, opposite direction to open hardware 410 and detach first strap end 407-1 and/or second strap end 407-2 from hardware 410.

The manner in which liner 140 is connected to and/or disconnected from fastening plate 325, as described above with respect to FIG. 4A, is provided for explanatory purposes only. In other implementations, the manner in which liner 140 is connected to and/or disconnected from fastening plate 325 may not be so limited. For example, a first strap 405 may be connected to fastening plate 325 and may include a first hardware portion (e.g., a female end of a quick release buckle). A second strap 405 may be connected to liner 140 and may include a second hardware portion associated with the first hardware portion (e.g., a male end of the quick release buckle). Thus, in this example, liner 140 may be connected to fastening plate 325 by connecting the first hardware portion to the second hardware portion. Additionally, or alternatively, liner 140 may be disconnected from fastening plate 325 by disconnecting first hardware portion from second hardware portion.

As illustrated in FIG. 4B, waste system portion 450 may include fasteners 330-2, and a portion of fastening plate 325 and liner 140. Each fastener 330-2 may include a flap 455, a flap adhesive patch 460 (hereinafter, “patch 460”), and/or a liner adhesive patch 470 (hereinafter, “patch 470”). Fastener 330-2 may enable liner 140 to be quickly and easily replaced by enabling liner 140 to be detached from and replacement liner 140 to be attached to lid 130 without scheduling a separate maintenance operation.

Flap 455 may include a portion of liner 140 material that extends or protrudes from an open end of liner 140 and is of sufficient flexibility and/or tensile strength to wrap around and/or attach to fastening plate 325 and/or liner 140 without failing or breaking particularly when liner 140 is at or near capacity, and/or when lid 130 and/or liner 140 are being hoisted from utility chamber 120. A first end of flap 455 may be attached and/or integrated into the material of liner 140 and a second end of flap 455, opposite of the first end, may include patch 460. Patch 460 may be a high strength, industrial, and/or permanent adhesive (e.g., contact adhesives, pressure sensitive adhesives, thermal adhesives, etc.) that bonds to a side of the second end of flap 455 and which faces the interior of liner 140. Patch 470 may be high strength, industrial, and/or permanent adhesive (e.g., drying adhesives, contact adhesives, pressure sensitive adhesives, thermal adhesives, etc.) that bonds to an interior side of liner 140 at a location that is below the first end of flap 455 and/or fastening plate 325.

By way of example, liner 140 may be attached to fastening plate 325 by wrapping the second ends of each flap 455 (e.g., flap 455-1, 455-2, etc.) around and/or over fastening plate 325 and bonding each patch 460 (e.g., patch 460-1, 460-2, etc.) to a respective patch 470 (e.g., patch 470-1, 470-2, etc.) located below the first end of each flap 455. Depending on the type of permanent adhesive used, the connection may be further secured by providing a compressive force and/or heat to patches 460 and 470 to cure and/or strengthen the adhesive bond. Attaching liner 140 to fastening plate 325 may be performed without scheduling a maintenance operation and/or within a fourth time period that is less than a fourth threshold. The fourth threshold being less than the first threshold described above. Liner 140 may be detached from fastening plate 325 by cutting each flap 455 and releasing each flap 455 from fastening plate 325. Cutting each flap 455 may also, or alternatively, be performed in the event that liner 140 becomes immovably lodged, jammed, or stuck in utility chamber 120, which may permit lid 130 from being removed in such an event. Disconnecting liner 140 from fastening plate 325 may be performed without scheduling a maintenance operation and/or within a fifth time period that is less than a fifth threshold; the fifth threshold being less than the second threshold. Disconnecting and reconnecting liner 140 to lid 130 in the manner described above, may be performed without scheduling a maintenance operation and/or within a time period that based on a combination of the fourth time period and fifth time period. The combination of the fourth and fifth time periods may be less than a sixth threshold. The sixth threshold may be less than the third threshold.

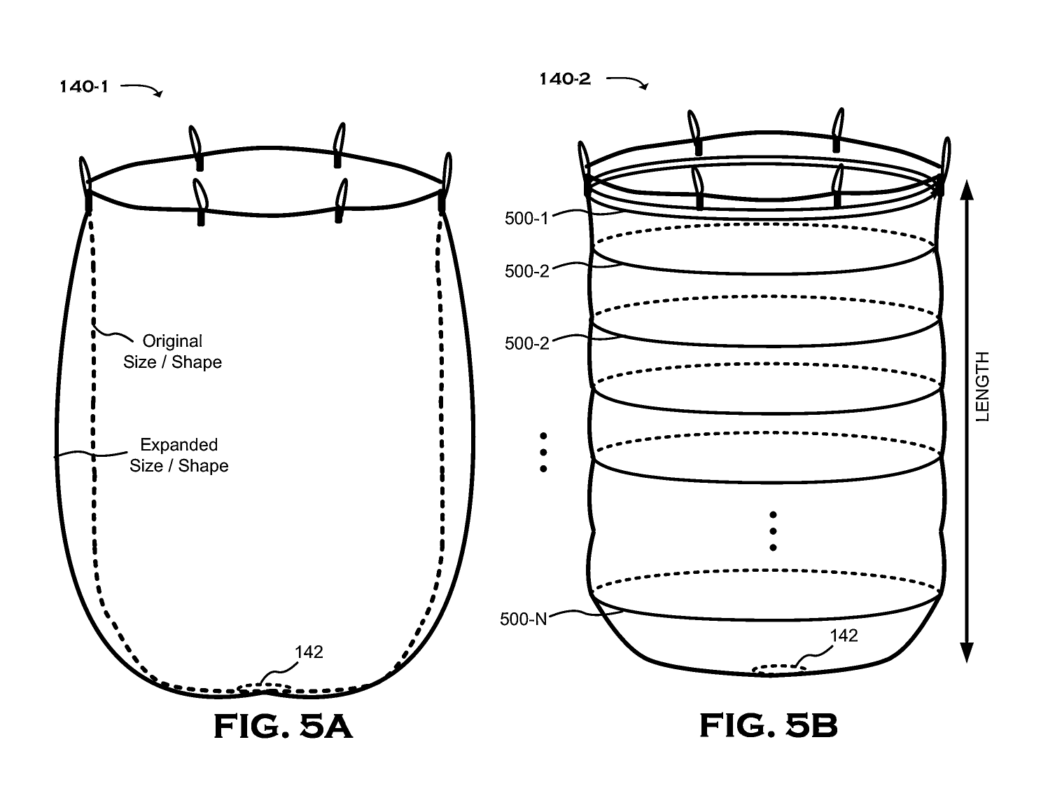

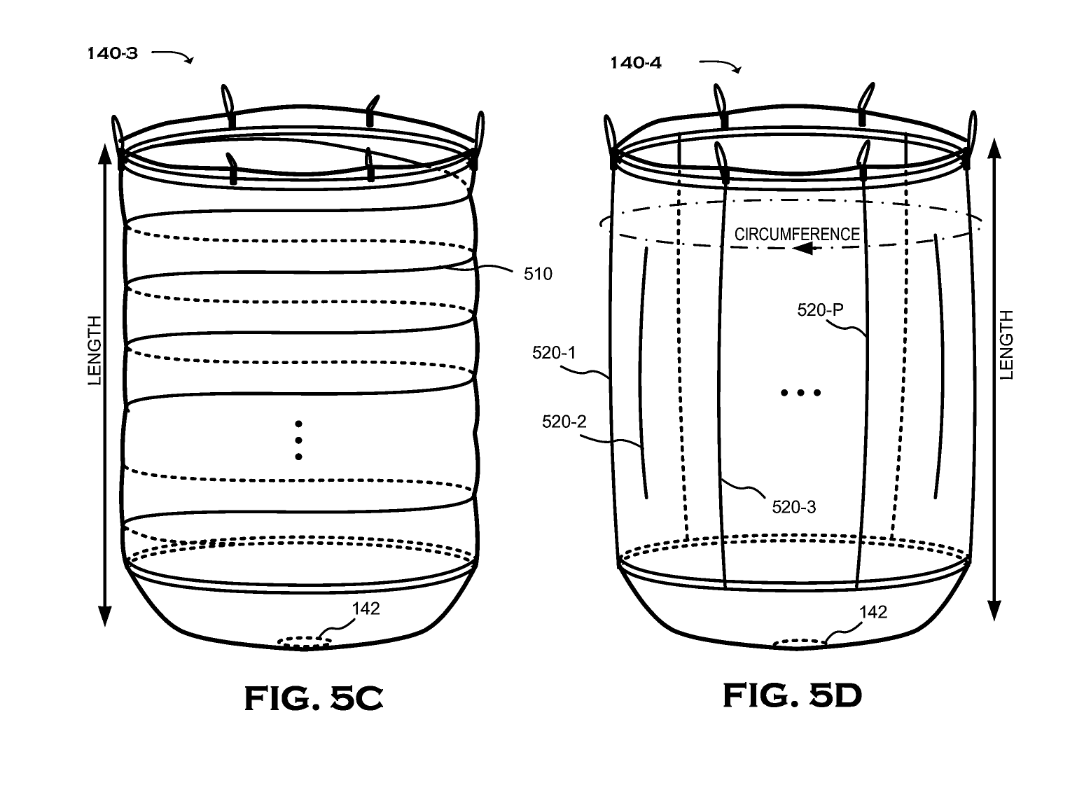

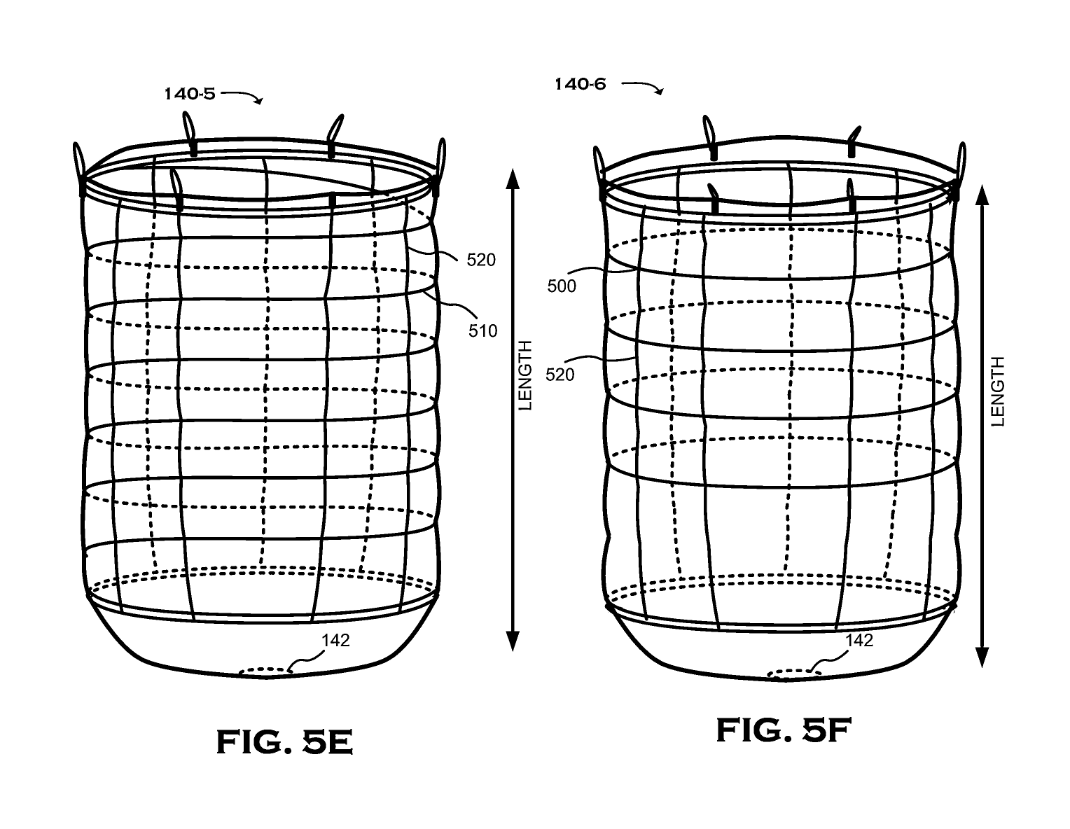

FIGS. 5A-5F are diagrams of example liners 140-1-140-6, respectively, that may be associated with semi-underground waste system 110. As illustrated in FIG. 5A, liner 140-1 may include an original shape, dimensions, and/or volume (e.g., shown as the dashed line labeled “original size/shape” in FIG. 5A) that fits within and/or is compatible with the inside shape, dimensions, or volume of utility chamber 120. When liner 140-1 is filled with waste, the weight, volume, and/or density of the waste may deform and/or expand liner 140-1 beyond the original shape, dimensions, and/or volume (e.g., shown as the solid line labeled “expanded size/shape” in FIG. 5A). Thus, deformed and/or expanded liner 140-1 may cause liner 140-1 to conform to the inside dimensions of utility chamber 120 and/or to make contact with and/or apply pressure to the sides of utility chamber 120, which may increase the friction force between liner 140-1 and utility chamber 120. The increase in friction may cause the deformed and/or expanded liner 140-1 to become immovably lodged, jammed, or stuck in utility chamber 120, which may preclude removal of expanded liner 140-1 from utility chamber 120 and/or the disposal of the waste stored within expanded liner 140-1.

FIG. 5B is a diagram of an example liner 140-2 that may be associated with semi-underground waste system 110. As illustrated in FIG. 5B, liner 140-2 may include a group of perimeter reinforcement components 500-1, 500-N (where N≧1) (hereinafter, collectively “perimeter reinforcements 500” and individually a “perimeter reinforcement 500”). Perimeter reinforcement 500 may include a component that enables liner 140-2 to maintain approximately the original shape, dimension, or volume when filled with waste, which may preclude liner 140-2 from conforming to the inside dimensions of utility chamber 120. For example, perimeter reinforcement 500 may include a wire, cable, cord, string, strap, belt, etc. that is fastened and/or integrated with the material from which liner 140-2 is made. The shape and/or dimension of perimeter reinforcement 500 may correspond to liner 140-2 when fully open and without being deformed and/or expanded, and/or without conforming to the inside of dimensions of utility chamber 120. Perimeter reinforcement 500 may also, or alternatively, be adhesive bonded, heat welded, riveted, fused with, and/or otherwise attached to the interior, exterior, and/or between two or more plies of liner 140-2. Additionally, or alternatively, perimeter reinforcement 500 may not expand or increase in size (e.g., diameter, circumference, etc.) due to the volume, weight, and/or density of waste that is held within liner 140-2, which may prevent liner 140-2 from deforming and/or expanding under the weight, volume and/or density of the waste.

By way of example, liner 140-2 may include a first density of perimeter reinforcements 500 that is based on a first quantity of reinforcements 500 per unit of length (L) of liner 140-2 (e.g., 1, 2, etc. perimeter reinforcements 500 per foot or some other first density of reinforcements 500) that provides a first amount of resistance to deformation and/or expansion. If a greater amount of resistance to deformation and/or expansion, relative to the first amount of resistance, is desired to prevent the deformation and/or expansion of liner 140-2, a second density of perimeter reinforcements 500 may be used to create the greater amount of resistance to deformation and/or expansion of liner 140-2. In this example, the second density of perimeter reinforcements 500 (e.g., 3, 4, 5, etc. perimeter reinforcements 500 per foot or some other second density of perimeter reinforcements 500) may be greater than the first density of perimeter reinforcements 500.

FIG. 5C is a diagram of an example liner 140-3 that may be associated with semi-underground waste system 110. As illustrated in FIG. 5C, liner 140-3 may include a spiral reinforcement component 510 (hereinafter, “spiral reinforcement 510”). Spiral reinforcement 510 may include a component that enables liner 140-3 to maintain approximately the original shape, dimension, or volume when filled with waste, which may preclude liner 140-3 from conforming to the inside dimensions of utility chamber 120. For example, spiral reinforcement 510 may include a continuous wire, cable, cord, string, strap, belt, etc, in a spiral and/or helical shape. Spiral reinforcement 510 may be fastened and/or integrated with the material, from which liner 140-3 is made, in one or more revolutions (e.g., each revolution being approximately 360 degrees) around the perimeter and/or circumference of liner 140-3. The shape and/or dimension of spiral reinforcement 510 may also, or alternatively, correspond to liner 140-3 when fully open and without being deformed and/or expanded inside utility chamber 120. Spiral reinforcement 510 may also, or alternatively, be adhesive bonded, heat welded, riveted, fused with, and/or otherwise attached to the interior, exterior, and/or between two or more plies of liner 140-3. Additionally, or alternatively, spiral reinforcement 510 may not expand or increase in size (e.g., diameter, circumference, etc.) due to the volume, weight, and/or density of waste that is held within liner 140-3, which may prevent liner 140-3 from deforming and/or expanding under the weight, volume and/or density of the waste.

By way of example, liner 140-3 may include a first density of spiral reinforcement 510 that is based on a first quantity of revolutions of spiral reinforcement 510 per unit length of liner 140-3 (e.g., 1, 2, etc. revolutions of spiral reinforcement 510 per foot or some other first density of reinforcement 510) that provides a third amount of resistance to deformation and/or expansion. If a greater amount of resistance to deformation and/or expansion, relative to the third amount of resistance, is desired to prevent the deformation and/or expansion of liner 140-3, a second density of spiral reinforcement 510 may be used to create the greater amount of resistance to deformation and/or expansion of liner 140-3. In this example, the second density of spiral reinforcement 510 (e.g., 3, 4, 5, etc. revolutions per foot or some other second density of spiral reinforcement) may be greater than the first density of spiral reinforcement 510.

FIG. 5D is a diagram of an example liner 140-4 that may be associated with semi-underground waste system 110. As illustrated in FIG. 5D, liner 140-4 may include a group of vertical reinforcement components 520-1, . . . , 520-P (where P≧1) (hereinafter, collectively “vertical reinforcements 520” and individually a “vertical reinforcement 520”). Vertical reinforcement 520 may include a component that enables liner 140-4 to maintain approximately the original shape, dimension, or volume when filled with waste, which may preclude liner 140-4 from conforming to the inside dimensions of utility chamber 120. For example, vertical reinforcement 520 may include extruded metal, a wire, a cable, a cord, a string, a strap, a belt, etc. that is fastened and/or integrated approximately length-wise within the material from which liner 140-4 is made. The length of vertical reinforcement 520 may extend for approximately all or a portion of the length of liner 140-4 when fully open and without being deformed and/or expanded. Vertical reinforcement 520 may also, or alternatively, be adhesive bonded, heat welded, riveted, fused with, and/or otherwise attached to the interior, exterior, and/or between two or more plies of liner 140-4. Additionally, or alternatively, vertical reinforcement 520 may not increase in length due to the volume, weight, and/or density of waste that is held within liner 140-4, which may prevent liner 140-4 from deforming, expanding, or lengthening under the weight, volume and/or density of the waste and/or when being hoisted from utility chamber 120. Vertical reinforcement 520 may also enable the structural integrity of liner 140-4 to remain intact particularly when being hoisted, along with lid 130, from utility chamber 120.

By way of example, liner 140-4 may include a first density of vertical reinforcements 520 that is based on the quantity of vertical reinforcements 520 (e.g., of one or more lengths) per unit of circumference (C) of liner 140-4 (e.g., 1, 2, etc. reinforcements 520 per foot of circumference or some other first density of vertical reinforcements 520) that provides a fifth amount of resistance to deformation and/or expansion. If a greater amount of resistance to deformation and/or expansion, relative to the fifth amount of resistance, is desired to prevent the deformation and/or expansion of liner 140-4, a second density of reinforcements 520 may be used to create the greater amount of resistance to deformation and/or expansion of liner 140-4. In this example, the second density of vertical reinforcements 520 (e.g., 3, 4, 5, etc. reinforcements 520 per foot of circumference or some other second density of vertical reinforcements 520) may be greater than the first density of vertical reinforcements 520.

FIGS. 5E and 5F are diagrams of example liners 140-5 and 140-6, respectively, that may be associated with semi-underground waste system 110. As illustrated in FIG. 5E, liner 140-5 may include a combination of spiral reinforcement 510 and one or more vertical reinforcements 520. Such a combination of spiral reinforcement 510 and vertical reinforcement 520 may provide greater resistance to deformation and/or expansion than that which can be provided by liners 140-1-140-4. Additionally, or alternatively, such combination of spiral reinforcement 510 and vertical reinforcement 520 may be more suitable for heavy duty industrial applications in which the weight, density, or volume of the waste is anticipated to be greater than that associated with waste for which liners 140-1-140-4 are used.

As illustrated in FIG. 5F, liner 140-6 may include a combination of one or more perimeter reinforcements 500 and one or more vertical reinforcements 520. Such a combination of perimeter reinforcement 500 and vertical reinforcement 520 may provide greater resistance to deformation and/or expansion than that which can be provided by liners 140-1-140-4. Additionally, or alternatively and in a manner similar to that described above with respect to FIG. 5E, such combination of perimeter reinforcement 500 and vertical reinforcement 520 may be more suitable for heavy duty and/or industrial applications in which the weight, density, or volume of the waste is anticipated to be greater than that associated with waste for which liners 140-1-140-4 are used.

The number of components shown with respect to liners 140-1-140-6 of FIGS. 5A-5F, respectively, is provided for explanatory purposes only. In practice, there may be additional components, fewer components, different components, or differently arranged components than illustrated in FIGS. 5A-5F. Also, in some implementations, one or more of the components of liners 140-1-140-6 of FIGS. 5A-5F, respectively, may perform one or more functions described as being performed by another one or more of the components of liners 140-1-140-6 of FIGS. 5A-5F, respectively.

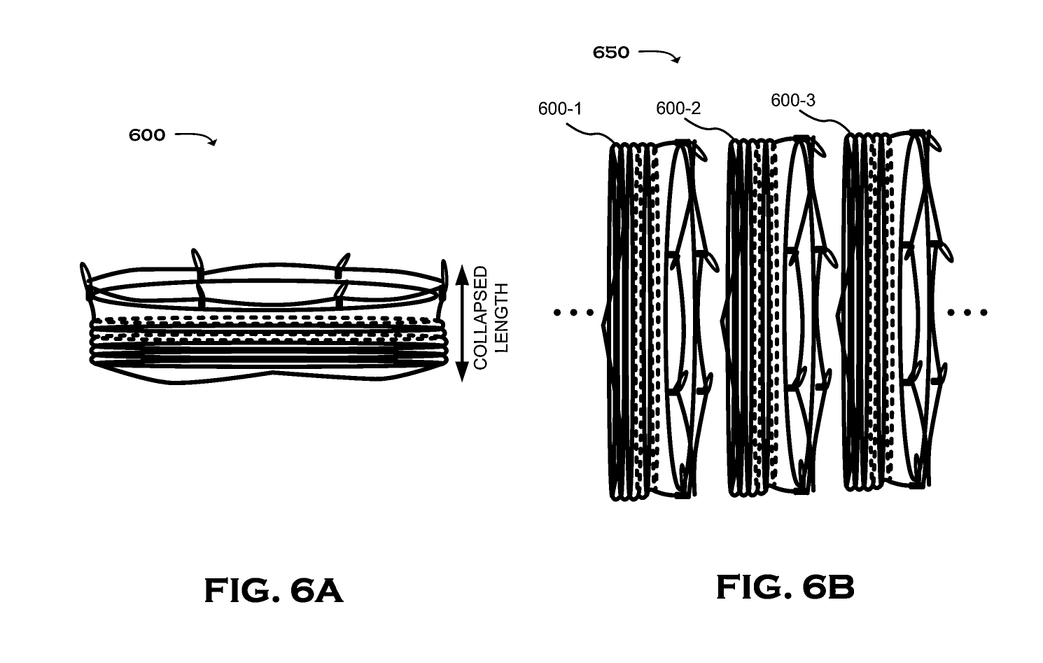

FIGS. 6A and 6B are diagrams of an example liner 600 and liner bundle 650, respectively, that may be associated with semi-underground waste system 110. Liner 600 of FIG. 6A may correspond to any of liners 140-1 of FIG. 5A, liner 140-2 of FIG. 5B, liner 140-3 of FIG. 5C, liner 140-4 of FIG. 5D, liner 140-S of FIG. 5E, or liner 140-6 of FIG. 5F that has been collapsed or compressed from an original length (e.g., shown as “length” in FIGS. 6A-5F) to a collapsible length that is less than the original length. The collapsed length may enable liner 600 to be easily transported and/or stored. For example, as shown in FIG. 6B, bundle 650 may include multiple liners 600 (e.g., 2, 4, 10, 20, etc.) that can be packed, stacked, stored, and/or transported in the same amount of space and/or volume that a single non-collapsed liner 140 can be packed, stored, and/or transported. Bundle 650 illustrates liners 600-1-600-3 in a horizontal stack configuration, but other bundle 650 configurations may be created (e.g., a vertical stack, etc.). The portability of liner 600 and/or bundle 650 may enable liners 600 to be carried in the field (e.g., via truck 150) and liners 140 to be removed and/or replaced during normal waste pickup and disposal operations without scheduling a separate maintenance action.

The technologies and/or techniques, described herein, may include a semi-underground waste system that uses in a new way a modified conventional pre-cast concrete manhole or pipe assembly that is usually used for public and/or industrial sewage or storm run-off water systems. A portion of the assembly may be installed in the ground and may resist buoyant forces due to the weight and non-tapered shape (e.g., cylindrical, cubical, etc.) of the assembly relative to conventional semi-underground systems. Additionally, or alternatively, the assembly may have greater capacity than the tapered shape of containers used in conventional semi-underground systems. The manhole or pipe assembly may be manufactured at numerous sites and manufacturers throughout the United States, Europe, Japan. These manufacturers are usually within short distances from each other (e.g., 50, 100, 150, etc. miles), which may render transportation costs for such manhole or pipe assemblies less than that associated with custom, pre-cast concrete containers used in conventional semi-underground systems. Additionally, or alternatively, the costs of the manhole or pipe assembly may be less than custom pre-cast concrete containers or non-concrete containers used in conventional semi-underground systems.

The technologies and/or techniques may also, or alternatively, include a flexible liner that is attached to a substructure of a lid that fits over an above-ground opening of the manhole or pipe assembly. The liner may be made of a single or multi-ply, environmentally compatible, and/or non-woven material that is breathable and resistant to water penetration, such as a flash spun, high-density polyethylene fiber material (e.g., the Tyvek® brand and/or other brand names), a PVC/EVA coated fabric material, a PEVA coated fabric material, a urethane coated fabric material, a polyurethane coated fabric material, and/or some other material. The cost of the liner material may be lower than that of woven textile liners of conventional semi-underground systems. The technologies and/or techniques my also, or alternatively, include an attachment and quick release mechanism that enables the liner to be easily and quickly removed and/or replaced from the cover without arranging a separate maintenance operation as is required for conventional semi-underground systems. The quick remove and replacement operation may be performed during normal waste pickup and disposal operations which may reduce operational costs of the semi-underground waste system relative to those of the conventional semi-underground system.

The technologies and/or techniques may include liner reinforcement components associated with the liner of the semi-underground waste system. The liner reinforcement components may include components, such one or more extruded metal, wires, cables, cords, straps, strings, ropes, etc. that are integrated or attached to the exterior, interior or between one or more plies of the liner to maintain approximately the original shape of the liner when waste is deposited within the liner and/or when the liner has reached capacity. Maintaining the approximate original shape of the liner may preclude the liner from expanding and/or deforming, and/or becoming immovably jammed, lodged, or stuck within the manhole or pipe assembly; thus, making the waste pickup and disposal operation difficult, more expensive, and more time consuming. Additionally, or alternatively, the liner reinforcement components may be integrated with the liner during manufacture, prior to shipping, or in the field during a removal or replacement operation of the liner. The liner reinforcement mechanism may be flexible so as to permit the flexible liner to be collapsed, folded, stacked, and/or bundled with other liners for efficient storage, shipping, and/or portability during field operations.

The foregoing description provides illustration and description, but is not intended to be exhaustive or to limit the implementations to the precise form disclosed. Modifications and variations are possible in light of the above disclosure or may be acquired from practice of the embodiments.

It will be apparent that technologies and/or techniques, as described above, may be implemented in many different forms of hardware in the implementations illustrated in the figures. The actual or specialized hardware used to implement these technologies and/or techniques is not limiting of the embodiments—it being understood that hardware can be designed to implement the technologies and/or techniques based on the description herein.

It should be emphasized that the terms “comprises”/“comprising” when used in this specification are taken to specify the presence of stated features, integers, steps or components but does not preclude the presence or addition of one or more other features, integers, steps, components or groups thereof.

Even though particular combinations of features are recited in the claims and/or disclosed in the specification, these combinations are not intended to limit the disclosure of the embodiments. In fact, many of these features may be combined in ways not specifically recited in the claims and/or disclosed in the specification. Although each dependent claim listed below may directly depend on only one other claim, the disclosure of the embodiments includes each dependent claim in combination with every other claim in the claim set.

No element, act, or instruction used in the present application should be construed as critical or essential to the embodiments unless explicitly described as such. Also, as used herein, the article “a” and “an” are intended to include one or more items and may be used interchangeably with “one” or “more.” Where only one item is intended, the term “one” or similar language is used. Further, the phrase “based on” is intended to mean “based, at least in part, on” unless explicitly stated otherwise.

What is claimed is:

1. A semi-underground waste system, comprising:
a utility chamber that is partially installed below a surface of ground,
a lid, removably attached to the utility chamber, that covers an opening in a portion of the utility chamber that is above the surface of the ground, and
a liner that stores waste and that includes one or more reinforcement components, the liner being located inside the utility chamber and being attached to the lid via the opening,
the one or more reinforcement components being of sufficient strength to preclude the liner from expanding or becoming stuck in the utility chamber after the waste is inserted in the liner or when the lid is removed from the utility chamber to dispose of the waste.

2. The semi-underground waste system of claim 1, where the utility chamber is made of precast concrete, an amount of weight of the precast concrete enabling the utility chamber to remain installed below the surface of the ground.

3. The semi-underground waste system of claim 1, where the utility chamber corresponds to a modified manhole that can be used in a water system or sewage system, the modified manhole not having any rungs of a ladder installed and including at least one of:
a first end that corresponds to the opening, or
a second end that is closed to preclude the waste from seeping into the ground, or water
or debris, from the ground, from entering the utility chamber.

4. The semi-underground waste system of claim 1, where the lid includes a substructure to at least one of:
enable the liner to be attached to the lid and removed from the utility chamber when the lid is removed from the utility chamber,
prevent the lid from distorting when waste is inserted in the liner, or
prevent the lid from distorting when the lid and the liner are removed from the utility chamber.

5. The semi-underground waste system of claim 1, where the lid includes one or more depressions to at least one of:
prevent the lid from distorting when waste is inserted in the liner, or
prevent the lid from distorting when the lid and the liner are removed from the utility chamber.

6. The semi-underground waste system of claim 1, where the lid includes a substructure to which the liner is attached, the substructure including one or more of:
a lifting ring with which to remove the lid from the utility chamber, or
one or more members attached to the lifting ring and to which the liner is attached.

7. The semi-underground waste system of claim 1, where the liner is made of at least one of:
a flash spun, high-density polyethylene fiber material,
a polyvinyl chloride/ethylene vinyl acetate (PVC/EVA) coated fabric material,
a polyethylene vinyl acetate (PEVA) coated fabric material,
a urethane coated fabric material, or
a polyurethane coated fabric material.

8. The semi-underground waste system of claim 1, where the liner includes one or more fasteners that enable the liner to be detached from the lid and a replacement liner to be attached to the lid within a time period that is less than a threshold,
the threshold corresponding to a particular time period after which a maintenance operation is to be scheduled.

9. The semi-underground waste system of claim 1, where the liner includes one or more fasteners, each of the one or more fasteners including a respective strap and a respective hardware component,
the respective strap including a first end and a second end, the first end being attached to the liner and the second end being attached to the respective hardware component, and
the respective hardware component enabling the respective strap to be attached to, or detached from, the lid within a time period that is less than a threshold,
the threshold corresponding to a particular time period after which a maintenance operation is to be scheduled

10. The semi-underground waste system of claim 1, where the one or more reinforcement components correspond to at least one of:
an extruded metal,
a cord,
a cable,
a strap,
a string,
a rope, or
a wire.

11. The semi-underground system of claim 1, where the one or more reinforcement components are at least one of:
attached to an exterior of the liner,
attached to an interior of the liner,
integrated between one or more plies associated with the liner.

12. The semi-underground waste system of claim 11, where the one or more reinforcement components correspond to at least one of:
a first shape associated with the perimeter of the liner,
a second shape associated with a spiral corresponding to the perimeter of the liner
a third shape that extends length-wise relative to a full or partial length of the liner, or
a combination of two or more of the first shape, the second shape, or the third shape.

13. The semi-underground waste system of claim 1, where the one or more reinforcement components correspond to a first density that enables the liner to apply a first amount of resistance to expansion of the liner after the waste is inserted in the liner,
the first density corresponding to a first quantity of the reinforcement components per unit of length of the liner.

14. The semi-underground waste system of claim 13, further comprising:
a particular liner to be used to replace the liner, the particular liner including one or more particular reinforcement components that correspond to a second density, the second density enabling the particular liner to apply a second amount of resistance to expansion of the particular liner after waste is inserted into the particular liner,
the second density being greater than the first density, and
the second amount of resistance being greater than the first amount of resistance.

15. A semi-underground waste system, comprising:
a utility chamber that includes a first portion and a second portion, the first portion being installed at or below a surface of ground, and the second portion being installed above the surface of the ground and including an opening that permits access to the first portion and the second portion,
a lid that covers the opening when the lid is removably attached to the second portion, and
a liner to store waste, the liner being located inside of the utility chamber and attached to the lid to permit the liner and the stored waste to be removed from the utility chamber when the lid is removed from the second portion, the liner including at least one of:
one or more reinforcements of sufficient strength to preclude the liner from becoming stuck in the utility chamber when the liner is at or near capacity to store the waste, or
one or more fasteners that enable the liner to be removed and replaced within a first time period that is less than a second time period to remove and replace a particular liner associated with a conventional semi-underground waste system.

16. The semi-underground waste system of claim 15, where the one or more reinforcements are of sufficient strength to at least one of:
preclude the liner from expanding to conform to one or more dimensions inside the utility chamber when the liner is at or near the capacity to store the waste.

17. The semi-underground waste system of claim 15, where each fastener, of the one or more fasteners, includes a strap and hardware, the strap and hardware enabling the liner to be:
attached to the lid by connecting the strap to the lid and engaging the hardware, and
detached from the lid by disengaging the hardware and disconnecting the strap from the lid.

18. The semi-underground waste system of claim 15, where each fastener, of the one or more fasteners, includes a flap and an adhesive, the strap and adhesive enabling the liner to be:
attached to the lid by wrapping the flap around a component of the lid and bonding the flap to the liner using the adhesive, and
detached from the lid by cutting the flap to release the flap from the component.

19. The semi-underground waste system of claim 15, where the utility chamber includes a seal between the first portion and the second portion, the seal precluding:
ground water, outside the utility chamber, from entering the utility chamber, or
the waste from entering the groundwater.

20. The semi-underground waste system of claim 15, where the utility chamber is made of a pre-cast concrete monolithic body that precludes:
ground water, outside the utility chamber, from entering the utility chamber, or
the waste from entering the groundwater.

21. A semi-underground waste device, comprising:
a liner that is made of a flexible material to store waste, the liner including a plurality of fasteners that are attached to an open end of the liner;
a lid to which the liner is attached by the plurality of fasters and that covers the open end of the liner, the plurality of fasteners enabling the liner to be detached from the lid and replaced within a first time period that is less than a second time period during which a conventional liner is removed and replaced from a conventional semi-underground waste system; and
a utility chamber, partially installed below ground, that includes an opening above the ground through which:
the liner can be inserted into the utility chamber when the lid is placed over the opening, or
the liner and the stored waste can be removed from the utility chamber when the lid is removed from the opening.

22. The semi-underground waste device of claim 21, where the flexible material includes one or more plies, at least one ply, of the one or more plies being environmentally compatible, breathable and resistant to water penetration.

23. The semi-underground waste device of claim 21, where the liner includes one or more heat welded seams.

24. The semi-underground waste device of claim 21, where the liner includes one or more reinforcements of sufficient strength to preclude the liner from becoming stuck in the utility chamber when the liner is at or near capacity to store the waste.

25. The semi-underground waste device of claim 24, where the flexible material and the one or more reinforcements enable the liner to be collapsed in a manner that permits the collapsed liner and one or more other collapsed liners to be stored, packaged or transported in a same amount of volume as the liner prior to being collapsed.

26. The semi-underground waste device of claim 21, where the utility chamber includes a lower portion and one or more upper portions, the lower portion including a first end that is closed to prevent water or debris from entering the utility chamber from the ground
some or all of the lower portion being installed below the ground, and
each of the one or more upper portions being stacked on a second end, of the lower portion, that is open to enable the liner to be inserted into the lower portion via the one or more upper portions.

27. The semi-underground waste device of claim 21, where at least one of the liner, the lid, or the utility chamber includes advertising content.
